(19) United States
(12) Patent Application Publication
(10) Pub. No.: US 2022/0274227 A1
(43) Pub. Date: Sep. 1, 2022

(54) MACHINE TOOL

(71) Applicant: Hilti Aktiengesellschaft, Schaan (LI)

(72) Inventor: Helmut HUMMEL, Marktoberdorf (DE)

(21) Appl. No.: 17/625,905

(22) PCT Filed: Jul. 14, 2020
(86) PCT No.: PCT/EP2020/069845

§ 371 Date: Jan. 10, 2022

(30) Foreign Application Priority Data
Jul. 24, 2019 (EP) 19188021.0

(51) Int. Cl. B24B 23/02; B24B 45/00; B24B 55/05

(52) U.S. Cl. CPC B24B 23/028; B24B 45/006; B24B 23/022; B24B 55/052

(57) ABSTRACT

A machine tool (1) is provided, in particular an angle grinder, including a spindle (8) that can be driven about a rotational axis (L), a device (9) being provided which can be fixed to the spindle (8) by a rotary connection. A separate securing device (26) is provided which is operatively connected to the spindle (8), which is arranged on the output side of the device (9), at least in some regions, and which, at least during operation of the machine tool (1), has a smaller outer diameter (28), at least in some regions, with respect to the rotational axis (L) than an outer diameter (14) of the spindle (8).

The present invention relates to a machine tool, in particular an angle grinder, comprising a spindle that can be driven about a rotational axis.

### BACKGROUND

In the case of hand-held angle grinders known from practice, it is known to fix a wheel to the spindle that can be fitted onto the spindle by means of a nut. In particular when the spindle accelerates or decelerates rapidly, the nut may become detached, with the result that the wheel may become detached from the spindle.

A quick-clamp apparatus for an angle grinder is known from WO 19030058 A1. Grinding wheels specifically adapted to the angle grinder are securely fixed to the spindle using a clamping device.

### SUMMARY OF THE INVENTION

However, in this design, only grinding wheels which are specifically designed and thus expensive to manufacture can be attached to the spindle.

It is an object of the present invention to provide a machine tool, in particular an angle grinder, with a spindle that can be driven about a rotational axis, it being possible for grinding wheels that can be produced inexpensively to be securely fixed to the spindle during operation of the machine tool.

The present invention provides a machine tool, in particular hand-held, and in particular an angle grinder, comprising a spindle that can be driven about a rotational axis, a device being provided which can be fixed to the spindle by means of a rotary connection. According to the invention, a separate securing device is provided which is operatively connected to the spindle, is arranged on the output side of the device, at least in some regions, and, at least during operation of the machine tool, has an outer diameter that is larger, at least in some regions, with respect to the rotational axis than an outer diameter of the spindle.

With a machine tool designed according to the invention, it can be ensured in a simple and inexpensive manner that the device which can be brought into operative connection with the spindle cannot become detached from the spindle during operation of the machine tool. This is achieved in particular by providing a separate element on the machine-tool side, which element prevents the device from becoming detached from the spindle due to the fact that, at least during operation of the machine tool, the separate element has, at least in some regions, a larger outer diameter than an outer diameter of the spindle. This reliably prevents injury to a user. Furthermore, in the machine tool according to the invention, it is advantageously possible to use different types of machining elements, such as grinding wheels, cutoff wheels, brushes or the like without special requirements with regard to anti-loosening protection, so that these can be implemented simply and inexpensively.

The solution according to the invention also has the advantage that it can be implemented independently of the type and size of the device used, and the securing device can therefore secure devices having different extensions in the longitudinal direction of the spindle. By means of the solution according to the invention, the device or the tool is reliably prevented from becoming detached from the spindle during operation even in the case of incorrect use by the user when fixing the device.

The securing device can also have a non-circular outer edge region, so that the securing device is not rotationally symmetrical with the rotational axis of the spindle. In this case, the outer diameter of the securing device should be understood to mean twice the value of a greatest spacing between a region of the securing device that faces away from the rotational axis and the rotational axis of the spindle.

In an advantageous embodiment of a machine tool, the device is designed as a tool or machining element having an internal thread, which can be brought into operative connection with an external thread of the spindle. The tool or machining element can be designed, for example, as a wheel, grinding wheel, cutoff wheel, brush or the like, the tool itself being connected to the spindle. Alternatively, the device can also be designed as a fastening nut having an internal thread, which can be brought into operative connection with an external thread of the spindle for fixing a tool or machining element. In this case, the fastening nut is preferably designed to fix a wheel, grinding wheel, cutoff wheel or the like which does not have an internal thread, with it being possible to fit the tool onto the spindle, for example.

In a simple and inexpensive embodiment of a machine tool according to the invention, the securing device has a threaded region having an external thread, by means of which the securing device can be brought into operative connection with a region of the spindle that has an internal thread, in particular runs in the longitudinal direction of the spindle and is arranged concentrically with respect to the rotational axis, a pitch of the thread of the securing device being smaller than a pitch of a thread of the device. Due to the smaller pitch of the thread of the securing device compared with the pitch of the thread of the device, the device is reliably prevented from becoming detached from the spindle even if the device is rotated relative to the spindle. The securing device preferably has a planar region which is arranged on one end of the spindle. The securing device is preferably arranged concentrically with respect to the rotational axis of the spindle.

In order to reliably prevent the device from becoming detached from the spindle, the securing device can be designed as a spring washer which is arranged in a groove of the spindle that in particular runs perpendicularly to the rotational axis, the spring washer being movable between a preloaded position, in which an outer diameter of the spring washer is smaller than or equal to the outer diameter of the spindle, and a relaxed position, in which the outer diameter of the spring washer is greater than the outer diameter of the spindle. In particular, the spring washer can have a continuous slit in the circumferential direction, which allows the outer diameter of the spring washer to be reduced. In order to allow the device to be arranged on the spindle and to be removed from the spindle counter to the spring force of the spring washer, the device can preferably have chamfers, in particular on both sides of an inner diameter viewed in the longitudinal direction of the spindle. In this case, a spring force of the spring washer is selected so as to be greater than a force that acts on the spring washer during operation when the device becomes detached.

The device can easily be prevented from becoming detached from the spindle if the securing device is designed as a lever which is pivotably articulated on the spindle and which, in particular under the action of centrifugal force, can be moved into a deflected position in which the lever has an outer diameter that is larger, at least in some regions, than the outer diameter of the spindle. In particular when the lever is designed in such a way that it is only moved into its deflected position by a centrifugal force that acts when the machine tool is in operation, the device can easily be attached and detached when the machine tool is not in operation.

The lever is preferably mounted on the spindle so as to be pivotable about an axis that is transverse to the rotational axis of the spindle, the lever being arranged in particular in a recess in the spindle. The lever can thus be easily pivoted between the use position and the non-use position, the lever allowing the device to be arranged on the spindle when in the non-use position and the lever thus preferably being arranged entirely within an envelope geometry predetermined by the outer diameter of the spindle.

In an advantageous development of the invention, a spring device is provided which applies a force to the lever which preloads the lever into its deflected position. In this way, it can be ensured in all operating states that the lever has, at least in some regions, a larger outer diameter than the spindle and that the device is thus securely held on the spindle. To remove or replace the device, the lever can, for example, be manually moved counter to the spring force of the spring device into a non-use position in which the device is removed from the spindle or can be arranged on the spindle.

In an advantageous embodiment of the invention, the lever has an end region on both sides of a fulcrum, each of the end regions being pivotable into the deflected position in which the particular end region has an outer diameter that is larger, at least in some regions, than the outer diameter of the spindle. This embodiment has the advantage that both devices with a large extension in the longitudinal direction of the spindle and devices with a small extension in the longitudinal direction of the spindle can be securely held on the spindle. In order to ensure advantageous anti-loosening protection, two spring devices can be provided which hold the lever in balance. A spacing between the two end regions of the lever in the longitudinal direction of the spindle is preferably greater than an extension of the device in the longitudinal direction of the spindle. The lever can, for example, be U-shaped or curved. In order to be able to reliably ensure the securing function of the lever, a thickness of the device in the longitudinal direction of the spindle is preferably smaller than a spacing between the end regions of the lever in the longitudinal direction of the spindle.

In an advantageous embodiment of the invention, the securing device is designed as an in particular planar element which is arranged in a recess in the spindle and can be moved in particular transversely to the rotational axis via a guide device. The planar element can be designed in such a way that it is transferred into the deflected position due to the centrifugal force which acts during operation of the machine tool, and holds the device securely on the spindle. The recess runs, for example, substantially in the longitudinal direction of the spindle or substantially transversely to the longitudinal direction of the spindle, the planar element being accordingly arranged substantially in the longitudinal direction or in the transverse direction of the spindle.

If the element has an obliquely running edge on an outer side that faces away from the rotational axis, the edge being at a greater spacing from the rotational axis in a region facing the spindle end than in a region facing away from the spindle end, the device can be in contact with the element independently of its extension in the longitudinal direction of the spindle, and be held without play in the longitudinal direction of the spindle during operation of the machine tool.

In order to ensure that the device is securely held in all operating states, a spring device can be provided which applies to the element a force that acts outwardly with respect to the rotational axis of the spindle. In order to arrange a device on the spindle or detach the device from the spindle, the element can be moved into its non-use position counter to the spring force of the spring device, for example manually or by means of a tool.

The element can be made simple to access, in particular to transfer the element from the use position into the non-use position, if the element is arranged at an output-side end of the spindle. The element can have, for example, an engagement element or an engagement opening for a tool, by means of which the element can be transferred from the use position to the non-use position. The recess can run substantially transversely to the longitudinal direction of the spindle.

Further advantages can be found in the following description of the drawings. Various embodiments of the present invention are shown in the drawings. The drawings, the description and the claims contain numerous features in combination. A person skilled in the art will expediently also consider the features individually and combine them to form useful further combinations.

### BRIEF DESCRIPTION OF THE DRAWINGS

In the drawings, identical and equivalent components are provided with the same reference signs.

In the drawings:

FIG. 1a is a simplified view of a hand-held machine tool designed as an angle grinder, a grinding wheel being arranged on a spindle by means of a fastening nut;

FIG. 1b is a greatly simplified view of the angle grinder according to FIG. 1a;

FIG. 2 is a section of an end region of the spindle of the machine tool according to FIGS. 1a and 1b, a securing device being arranged on the spindle;

FIG. 3 is a section of an alternatively designed end region of the spindle having a groove running perpendicularly to a longitudinal direction of the spindle, in which groove a spring washer is arranged;

FIG. 4 is a section of another alternatively designed end region of the spindle, a lever being pivotably mounted in a recess in the spindle;

FIG. 5 is a section of another alternatively designed end region of the spindle, a lever designed so as to have two end regions being pivotably mounted in a recess in the spindle;

FIG. 6 is a section of another alternatively designed end region of the spindle, an element which can be moved perpendicularly to the longitudinal direction being arranged in a recess of the spindle that runs in the longitudinal direction;

FIG. 7 is a sectional view of the spindle according to FIG. 6 along the line VII-VII;

FIG. 8 is a section of another alternatively designed end region of the spindle, an element which can be moved perpendicularly to the longitudinal direction being arranged in a recess that runs perpendicularly to the longitudinal direction of the spindle, said element being shown in a use position;

FIG. 9 is a section corresponding to FIG. 8, the movable element being shown in a non-use position; and

FIG. 10 is a plan view of the spindle according to FIG. 8 and FIG. 9, in which a guide groove for moving the element can be seen.

### DETAILED DESCRIPTION

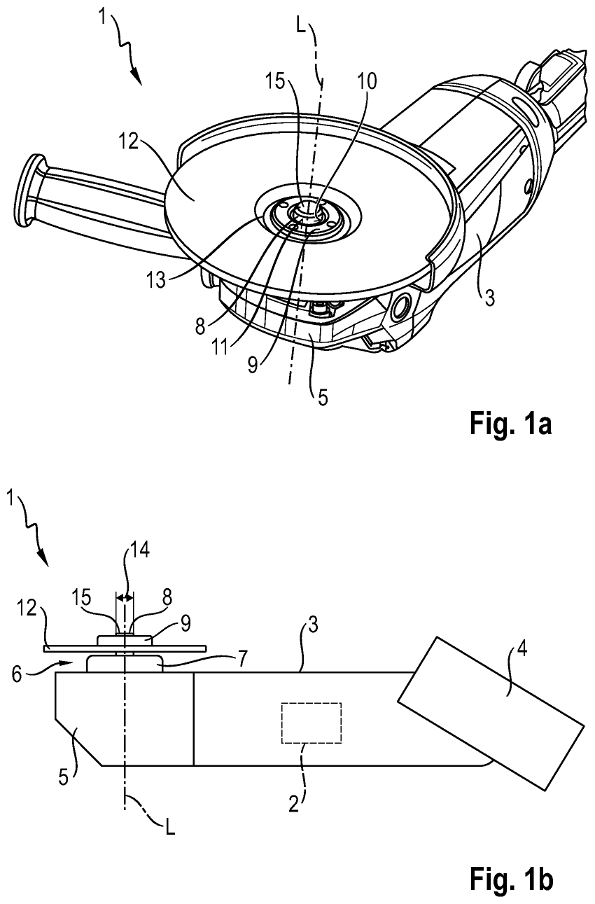

FIGS. 1a and 1b show a greatly simplified view of a machine tool 1, designed here as an angle grinder, in particular a hand-held machine tool. The machine tool 1 contains a housing 3, an accumulator 4 which is connected to the housing 3 as a power supply, and a head 5 having a tool holder 6. The tool holder 6 contains a flange 7, a spindle 8 and a device 9. The device 9, designed here as a clamping element or fastening nut, has an internal thread 10, by means of which the device 9 can be arranged on an external thread 11 of the spindle 8 that defines an outer diameter 14 of the spindle 8, and by means of which said device can be moved in the longitudinal direction L of the spindle 8. The spindle 8 is used to arrange a tool 12, for example a grinding or cutoff wheel, and to transmit a torque from an electric motor 2 to the tool 12.

The tool 12 has a central through-bore 13, the tool being fitted onto the spindle 8 via the through-bore 13 and being able to be attached by means of the device 9. The spindle 8 is attached to the head 5 of the machine tool 2 and mounted so as to be rotatable about the longitudinal axis L by means of a flange 7. The flange 7 is positioned on the head 5 of the machine tool 2 below the spindle 8 with respect to the longitudinal direction L of the spindle 8.

Various designs of a securing device are described below, each of which is partially or completely arranged on a side of the tool 12 and/or the fastening nut 9 that faces away from the head 5 of the machine tool 1, and, at least in the operating state of the machine tool 1 when the spindle 8 is rotating, the tool 12 and/or the fastening nut 9 is reliably prevented from becoming detached from the spindle 8 because, during operation of the machine tool 1, the relevant securing device assumes a use position on a side of the device 9 that faces away from the head 5, in which position an outer diameter of the securing device is larger, at least in some regions, than the outer diameter 14 of the spindle 8. A region of the relevant securing device that faces away from the longitudinal axis L can be at a greater spacing from the longitudinal axis L than the spindle 8 in at least one peripheral region of the longitudinal axis L. One such case is also described below, in that an outer diameter of the relevant securing device has a larger outer diameter than the spindle 8. The non-use position refers to a position of the securing device in which the securing device is arranged entirely within an envelope geometry of the spindle 8 and the device 9 can thus be screwed onto the spindle 8 without being hindered by the securing device.

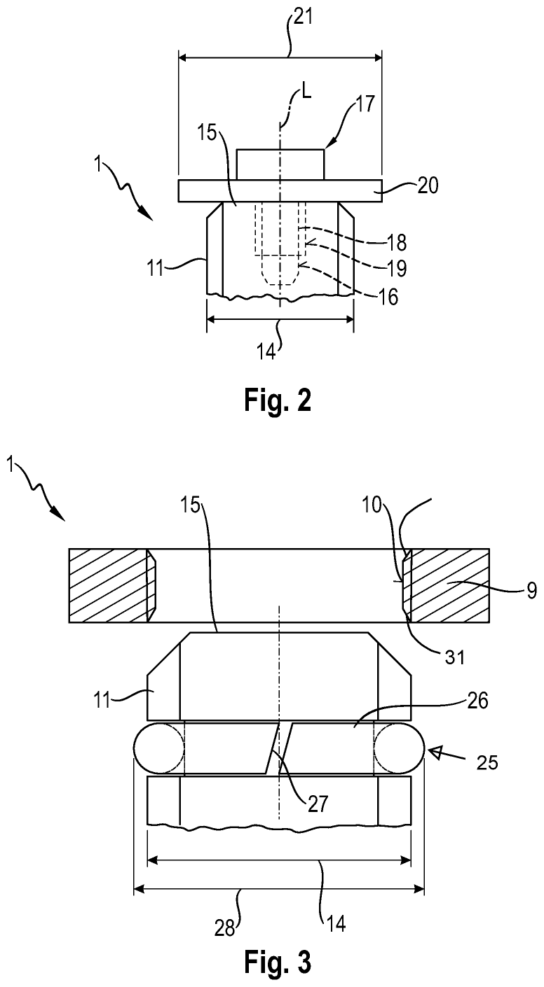

FIG. 2 shows, in a greatly simplified manner, an end region of the spindle 8, with an internal thread 16 extending, from an end 15 of the spindle 8 that faces away from the head 5 of the machine tool 2, concentrically with respect to the spindle 8 in the longitudinal direction L of the spindle 8. A securing device 17 is in operative connection with the internal thread 16, which securing device has a pin-like region 18 having an external thread 19, by means of which the securing device 17 interacts with the internal thread 16 of the spindle 8. A planar region 20, which in this case is circular and has a larger outer diameter 21 than the spindle 8, is connected to the pin-like region 18 of the securing device 17.

The thread pairing 16, 19 has a smaller pitch than the external thread 11 of the spindle 8. If, during operation of the machine tool 1, the fastening nut 9 detaches with respect to the spindle 8 and comes into contact with the planar region 20 of the securing device 17, the appropriate choice of the pitches of the threads 16, 19, 11, 10 results in different axial rotational offsets which bring about a locking, so that detachment of the securing device 17 from the spindle 8 and thus of the tool 12 from the spindle 8 is reliably prevented. Depending on the design of the tool 12 used, the securing device 17 can rest against the tool 12 in the longitudinal direction L or be spaced apart from said tool in the installed state of the tool 12.

In the embodiment according to FIG. 3, a groove 25, in which a securing device 26, here a spring device 26 designed as a spring washer and which runs perpendicularly to the longitudinal direction L, is arranged in a region that is spaced apart from the end 15 of the spindle 8. The spring washer 26 has a recess 27 in the circumferential direction U, and therefore the spring washer 26 can be moved under the action of force between a use position, in which an outer diameter 28 of the spring washer 26 is greater than the outer diameter 14 of the spindle 8, and a preloaded position, in which the outer diameter 28 of the spring washer 26 is smaller than or equal to the outer diameter 14 of the spindle 8.

The fastening nut 9 is shown sectionally in FIG. 3, where it can be seen that the fastening nut 9 is designed to have a chamfer 31, 32 in each axial end region in the region of its internal thread 10, such that the fastening nut 9 can be screwed onto the spindle 8 or removed therefrom under the application of a defined force in the longitudinal direction L via the spring washer 26. The force required for this is coordinated with the spring force of the spring washer 26 in particular such that it is greater than the forces which occur during operation of the machine tool 1 and which act on the spring washer 26.

In this solution, too, depending on the tool 12 used, the tool 12 or the fastening nut 9 can rest against the spring washer 26 in the longitudinal direction L in the installed state, or there can be a spacing between the two.

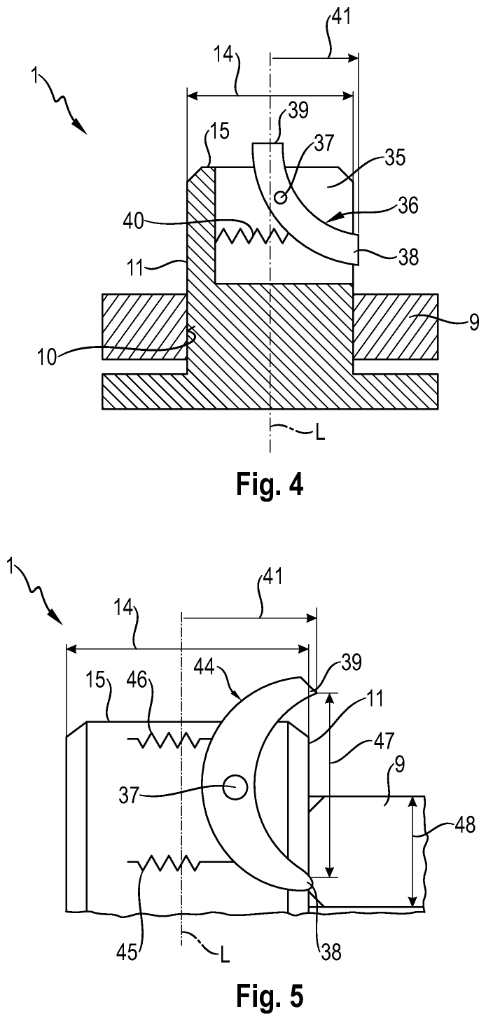

FIG. 4 shows another embodiment. Here, the spindle 8 has a recess 35 which extends from the end 15 in the longitudinal direction L, and in which a securing device designed as a lever 36 is mounted so as to be pivotable about a pivot axis 37 that runs perpendicularly to the longitudinal direction L. The lever 36 is mounted in such a way that, when the machine tool 1 is in operation and the spindle 8 is rotating about the longitudinal axis L, the centrifugal force acting in the process moves the lever into a use position in which a region of a first end region 38 of the lever 36 that faces away from the rotational axis L has a greater spacing 41 from the rotational axis L, at least in some regions, than an outer side of the spindle 8. An outer diameter of the lever 36 is thus greater than the outer diameter 14 of the spindle 8. As a result, when the tool 12 and the fastening nut 9 are installed, the fastening nut 9 and the tool 12 are reliably prevented from becoming detached.

In this case, in order to ensure a secure transfer of the lever 36 into the use position, a spring device 40 is provided which applies to the lever 36 a force which pushes in the direction of the use position. In the embodiment shown, the lever 36 has a second end region 39 which is arranged on a side of the pivot axis 37 that faces away from the first end region 38 and which protrudes beyond the end 15 of the spindle 8 in the longitudinal direction L. Using the second end region 39, the lever 36, in particular for installing or uninstalling a tool 12, can be moved easily from the use position into a release position in which the lever 36 is arranged entirely within an envelope geometry of the spindle 8 and thus does not protrude beyond the outer diameter 14 of the spindle 8.

FIG. 5 shows an alternative embodiment of a securing device 44, which is designed here as a curved lever 44 that is mounted on the spindle 8 so as to be rotatable about the pivot axis 37. Using the lever 44, anti-loosening protection is ensured or the fastening nut 9 or the tool 12 is reliably prevented from becoming detached from the spindle 8, even when a tool 12 and a fastening nut 9 are used which overall have a large extension in the longitudinal direction L of the spindle, or when a tool 12 which is itself connected to the spindle 8 via a thread and has a large extension in the longitudinal direction L of the spindle 8.

The lever 44 in turn has two end regions 38 and 39, both end regions 38, 39 being movable into a use position in which the relevant end region 38, 39 protrudes beyond the envelope geometry of the spindle 8, and a region of the relevant end region 38, 39 that faces away from the rotational axis L thus having a greater spacing 41 from the rotational axis L, at least in some regions, than an outer contour of the spindle 8. In this case, the end region 39 which is more remote from the head 5 is arranged in such a way that it reliably prevents the tool 12 and/or the fastening nut 9 from becoming detached from the spindle 8. The end region 39 is particularly effective when an extension of the tool 12 and/or the fastening nut 9 in the longitudinal direction L of the spindle 8 is so great that they push the other end region 38 into the non-use position.

An outer diameter of the lever 44 is thus greater than the outer diameter 14 of the spindle 8. A spacing 47 between the end regions 38, 39 in the longitudinal direction L of the spindle 8 is greater than an extension 48 of the fastening nut 9 or of the tool 12 in the longitudinal direction L of the spindle 8, the lever 44 being held in balance by two spring devices 45, 46 in this case.

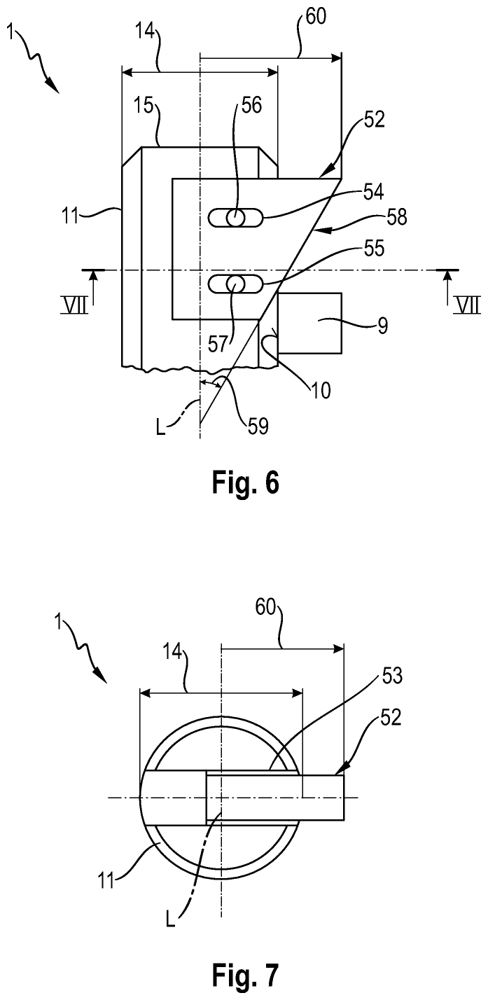

Another embodiment of a securing device 52 is shown in FIG. 6, the securing device 52 being designed here as a planar securing element which is arranged in a recess 53 (see FIG. 7) which extends in the longitudinal direction L of the spindle 8, and which can be seen in greater detail in FIG. 7. In this case, the securing element 52 has two elongate holes 54, 55, in which pins 56, 57, which are arranged on the spindle 8, are guided. The securing element 52 can thus be moved perpendicularly to the longitudinal direction L with respect to the spindle 8, the securing element 52 being pushed outward as far as possible with respect to the longitudinal axis L when the machine tool 1 is in operation due to the acting centrifugal force. A spring device which applies a force to the securing element 52 into the use position, i.e. into the outwardly pushed position, can also be provided.

In the use position shown in FIG. 6 and FIG. 7, a spacing of a side of the securing element 52 that faces away from the longitudinal axis L is greater in a peripheral region of the rotational axis than a spacing of the outer contour of the spindle 8, and therefore an outer diameter of the securing element 52 is greater than the outer diameter 14 of the spindle 8.

The securing element 52 is designed in such a way that it can be moved from the use position into the non-use position, the securing element 52 not protruding beyond an envelope geometry of the spindle 8 in the non-use position and it being possible to install or uninstall a tool 12 and/or the fastening nut 9 without being hindered by the securing element 52.

A side boundary 58 of the securing element 52 that faces away from the longitudinal axis L of the spindle 8 of the longitudinal axis L designed to be oblique in the this case, i.e. the side boundary 58 encloses an angle 59 with the longitudinal direction L, with an end of the securing element 52 that faces the end 15 of the spindle 8 being at a greater spacing from the longitudinal axis L of the spindle 8 than an end of the securing element 52 that faces away from the end 15 of the spindle 8. This embodiment of the securing element 52 has the advantage that, with various tools 12 which can be brought into operative connection with the spindle 8, the securing element 52 is in contact with the tool 12 or the fastening nut 9 in the installed state, and the tool 12 or the fastening nut 9 is thus clamped in the installed position as a result of the self-locking, and detachment is thus reliably prevented.

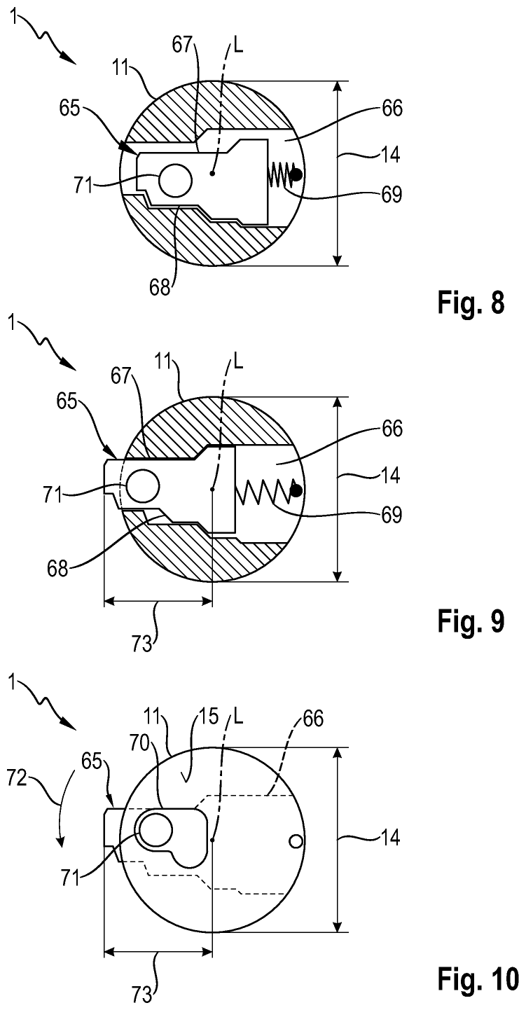

Another embodiment of a securing device 65 is shown in FIG. 8 to FIG. 10. The securing device 65 is in turn designed as a securing element which is arranged in a recess 66 in the spindle 8. FIG. 8 and FIG. 9 are sectional views through a region of the spindle 8 in which the securing element 65 is arranged.

FIG. 9 shows the securing element 65 in the use position, in which the securing element 65 protrudes beyond the envelope geometry of the spindle 8 in the radial direction and a spacing 73 of a region of the securing element 65 that faces away from the longitudinal axis L is greater than a spacing of the outer contour of the spindle 8 from the longitudinal axis L. The securing element 65 thus has a larger outer diameter than the outer diameter 14 of the spindle 8, at least in some regions. The securing element 65 is pushed into the position shown by means of a spring device 69 and is supported in this position against flanks 67, 68 of the recess 66.

FIG. 8 shows the securing element 65 in the non-use position, in which the securing element 65 is arranged entirely in an envelope geometry of the spindle 8 and thus does not protrude beyond the outer diameter 14 of the spindle 8.

In this case, the securing element 65 has a recess 71 designed to interact with a tool, the securing element being movable into the non-use position counter to the spring force of the spring device 69 by means of the tool. As can be seen in FIG. 10, the spindle 8 has a guide device in the form of a guide curve 70 arranged at its end 15, the securing element 65 being movable from the use position to the non-use position by means of a tool that can be brought into engagement with the securing element 65 via the guide curve 70.

The guide curve 70 is designed in such a way that during such a movement, the securing element 65 undergoes a rotational movement in addition to a translational movement in the direction of a central axis of the spindle 8. The flanks 67, 68 of the recess 66 are designed in such a way that, in the non-use position, the securing element 65 assumes a locked position in which the spring force of the spring device 69 does not move the securing element 65 into the use position when the spindle 8 is stationary. In this state, the tool 12 and/or the fastening nut 9 can be installed or uninstalled.

When the machine tool 1 is transferred to an operating state, and thus when the spindle 8 is subjected to a rotary movement according to the arrow 72, the securing element 65 is released from the locked position without further actuation and is transferred to the use position.

The securing devices designed according to the invention are suitable both for the use of a tool 12 which is fixed on the spindle 8 via a fastening nut 9 and for the use of a tool 12 which itself has an internal thread and can be fixed to the spindle 8.

What is claimed is:

1-12. (canceled)

13. A machine tool comprising:
a spindle drivable about a rotational axis and having a spindle outer diameter;
a device fixable to the spindle via a rotary connection; and
a separate securing device operatively connected to the spindle and arranged on an output side of the device, at least in some regions, the securing device, at least during operation of the machine tool, being at a greater spacing from a longitudinal axis than the spindle in a region facing away from the rotational axis in at least one peripheral region of the rotational axis, and having an outer diameter at least larger, at least in some regions, with respect to the rotational axis than the spindle outer diameter.

14. The machine tool as recited in claim 13 wherein the device is a tool or machining element having an internal thread capable of operative connection with an external thread of the spindle.

15. The machine tool as recited in claim 13 wherein the device is a fastening nut having an internal capable of operative connection with an external thread of the spindle for fixing a machining element.

16. The machine tool as recited in claim 13 wherein the securing device has an external thread, the securing device capable of operative connection via the external thread with an internal thread of the spindle.

17. The machine tool as recited in claim 16 wherein device is a fastening nut and the internal threads extend in a longitudinal direction of the spindle and are arranged concentrically with respect to the rotational axis, a pitch of the external thread of the securing device being smaller than a pitch of a thread of the fastening nut.

18. The machine tool as recited in claim 13 wherein the securing device is a spring washer is arranged in a groove of the spindle, the spring washer being movable between a preloaded position where an outer diameter of the spring washer being smaller than or equal to the outer diameter of the spindle and a relaxed position where the outer diameter of the spring washer is larger than the spindle outer diameter.

19. The machine tool as recited in claim 13 wherein the groove runs perpendicularly to the rotational axis.

20. The machine tool as recited in claim 13 wherein the securing device a lever pivotably articulated on the spindle and movable moved via centrifugal force into a deflected position where the lever has an outer diameter larger, at least in some regions, than the spindle outer diameter.

21. The machine tool as recited in claim 20 wherein the lever is mounted on the spindle so as to be pivotable about an axis transverse to the rotational axis of the spindle.

22. The machine tool as recited in claim 20 further comprising a spring applying to the lever a force preloading the lever into its deflected position.

23. The machine tool as recited in claim 20 wherein the lever has an end region on both sides of a fulcrum, each of the end regions being pivotable into the deflected position where one of the end regions has a larger outer diameter, at least in some regions, than the spindle outer diameter.

24. The machine tool as recited in claim 13 wherein the securing device is a recessable element arranged in a recess in the spindle movable via a guide device.

25. The machine tool as recited in claim 24 wherein the recessable element is a planar element movable transversely to the rotational axis via the guide device.

26. The machine tool as recited in claim 24 wherein the recessable element has an obliquely running edge on an outer side facing away from the rotational axis, the edge having a greater spacing from the rotational axis in a region facing an end of the spindle than in a region facing away from the spindle end.

27. The machine tool as recited in claim 24 further comprising a spring applying to the recessable element a force acting outwardly on the recessable element with respect to the rotational axis of the spindle.

28. The machine tool as recited in claim 24 wherein the recessable element is arranged on a output-side end of the spindle.

29. An angle grinder comprising the machine tool as recited in claim 13.
